(19) United States
(12) Patent Application Publication
(10) Pub. No.: US 2016/0276816 A1
(43) Pub. Date: Sep. 22, 2016

(54) WIRING UNIT AND PRODUCTION METHOD THEREOF

(71) Applicant: AISAN KOGYO KABUSHIKI KAISHA, Obu-shi (JP)

(72) Inventor: Masahiro HACHIYA, Chita-shi (JP)

(73) Assignee: AISAN KOGYO KABUSHIKI KAISHA, Obu-shi (JP)

(21) Appl. No.: 15/063,123

(22) Filed: Mar. 7, 2016

(30) Foreign Application Priority Data
Mar. 18, 2015 (JP) 2015-054866

(51) Int. Cl. H02G 3/08; H02G 1/14

(52) U.S. Cl. CPC H02G 3/081; H02G 1/145

(57) ABSTRACT

A wiring unit for an electronic circuit includes a housing made from a resin material, a first conductive member, and a second conductive member. The first and second conductive members are each partially buried in the housing. Each of the first and second conductive members includes a wiring part formed in a plate shape. The wiring parts of the first and second conductive members are layered and are spaced from each other. One of the first and second conductive members includes a plurality of protrusions extending toward the other one of the first and second conductive members. The first and second conductive members are engaged with each other via the protrusions.

### CROSS-REFERENCE TO RELATED APPLICATIONS

This application claims priority to Japanese patent application serial number 2015-054866, filed Mar. 18, 2015, the contents of which are incorporated herein by reference in their entirety for all purposes.

### STATEMENT REGARDING FEDERALLY SPONSORED RESEARCH OR DEVELOPMENT

Not applicable.

### BACKGROUND

This disclosure relates to a wiring unit and a production method thereof. In particular, the wiring unit includes a housing made from a resin material and conductive members constituting an electronic circuit and partially buried in the housing.

Japanese Laid-Open Patent Publication No. 2012-164447 discloses a conventional wiring unit made by layering a pair of plate-shaped conductive members constituting an electronic circuit and then molding a resin material into the form of the wiring unit that includes conductive members therein. During the insert molding thereof, the conductive members as an insert material are held on a supporting base. The supporting base has protrusions for providing a space between the conductive members such that the conductive members do not electrically contact each other.

The production method of the wiring unit of Japanese Laid-Open Patent Publication No. 2012-164447 requires the supporting base. Thus, the number of components used for the production of the wiring unit is increased, so that the production cost is increased. Accordingly, there has been a need for an improved wiring unit.

### BRIEF SUMMARY

In one aspect of this disclosure, a wiring unit for an electronic circuit includes a housing made from a resin material and a pair of first and second conductive members partially buried in the housing. Each of the first and second conductive members includes a wiring part formed in a plate shape. The wiring parts of the first and second conductive members are layered and are spaced from each other. One of the first and second conductive members includes a plurality of protrusions extending toward the other one of the first and second conductive members. The first and second conductive members are engaged with each other via the protrusions.

According to the aspect of this disclosure, the first and second conductive members can be spaced apart from each other via the protrusions without using other tools, so that the production cost can be decreased.

### BRIEF DESCRIPTION OF THE DRAWINGS

FIG. 1 is a perspective view of a wiring unit according to a first embodiment that includes conductive members.

FIG. 2 is a perspective view of the bottom of the wiring unit.

FIG. 3 is a perspective view of the coupled conductive members used for an insert molding, wherein an upper one of the conductive members has protrusions.

FIG. 4 is a perspective view of the bottom of the coupled conductive members of FIG. 3.

FIG. 5 is a partially cross-sectional side view of the conductive members of FIG. 3.

FIG. 6 is a cross-sectional side view of one of the protrusions of FIG. 5.

FIG. 7 is a cross-sectional side view of one of the protrusions according to a second embodiment.

FIG. 8 is a cross-sectional side view of one of the protrusions according to a third embodiment.

### DETAILED DESCRIPTION

Each of the additional features and teachings disclosed above and below may be utilized separately or in conjunction with other features and teachings to provide an improved wiring unit and an improved production method thereof. Representative examples, which utilize many of these additional features and teachings both separately and in conjunction with one another, will now be described in detail with reference to the attached drawings. This detailed description is merely intended to teach a person skilled in the art further details for practicing preferred aspects of the present teachings and is not intended to limit the scope of the invention. Only the claims define the scope of the claimed invention. Therefore, combinations of features and steps disclosed in the following detailed description may not be necessary in the broadest sense, and are instead taught merely to particularly describe representative examples. Moreover, various features of the representative examples and the dependent claims may be combined in ways that are not specifically enumerated in order to provide additional useful embodiments of the present teachings.

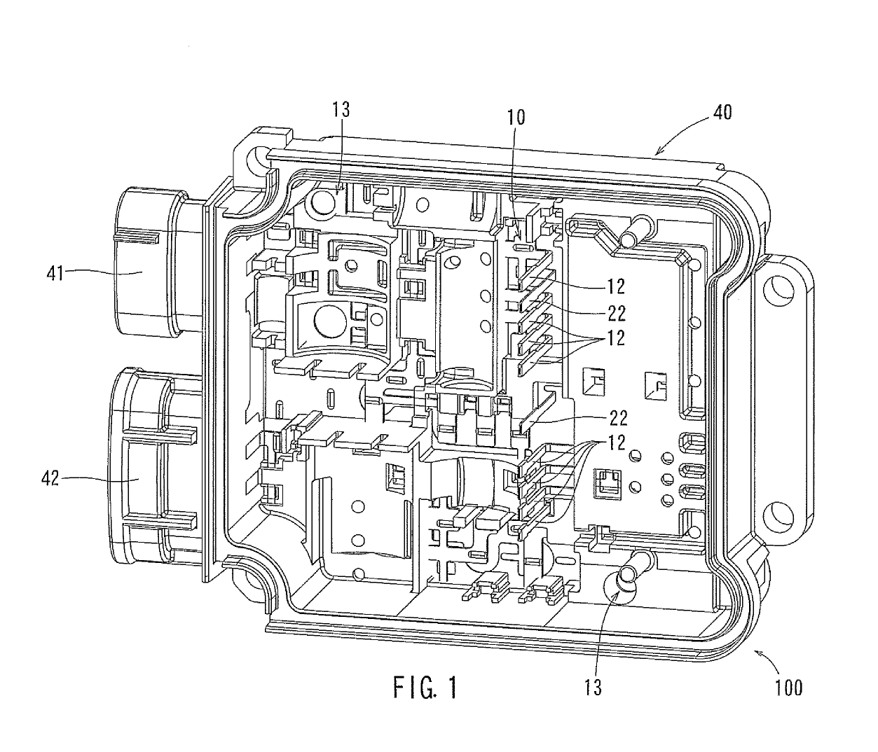

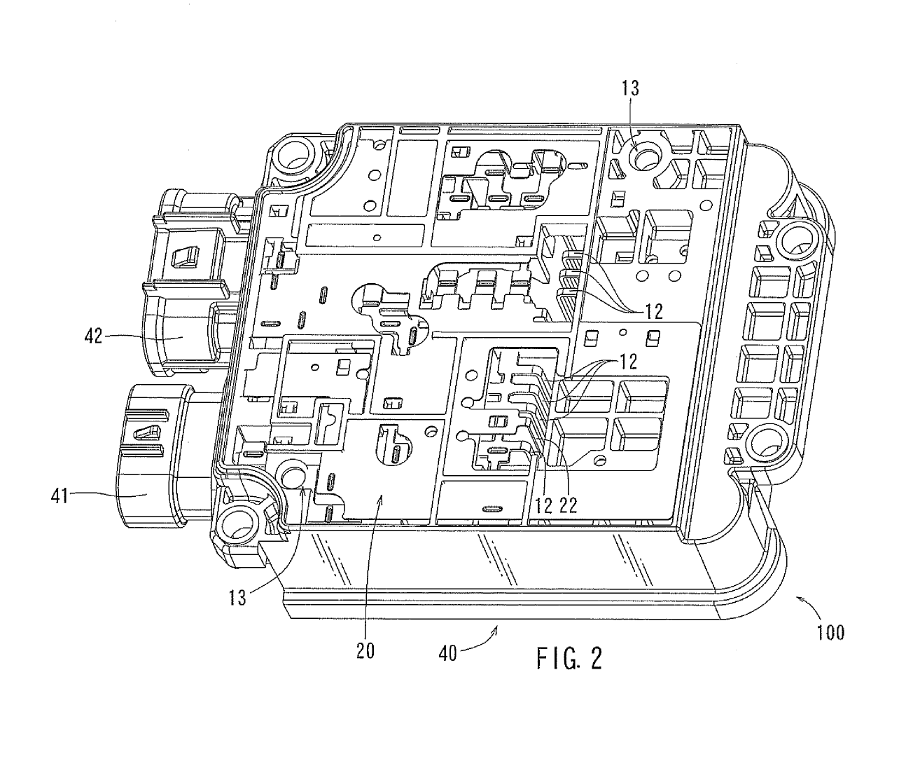

A wiring unit 100 according to a first embodiment will be described in view of the drawings. FIGS. 1 and 2 show the wiring unit 100 composed of plate-shaped first and second conductive members 10, 20 and a housing 40 made from a resin material. The first and second conductive members 10, 20 constitute lines of an electronic circuit of the wiring unit 100 and are partially buried in the housing 40 in a condition where the first and second conductive members 10, 20 are layered with a predetermined space therebetween. Each of the first and second conductive members 10, 20 is made by punching a square copper plate. The housing 40 is formed in a square box-like shape having an upper opening and is shaped to fully cover each outer circumference of the first and second conductive members 10, 20. The housing 40 is configured such that various electronic components (not shown), such as integrated circuit (IC) or capacitor, can be electrically connected to the first and second conductive members 10, 20 and can be housed in the housing 40 and held at an upper side of the housing 40 (FIG. 1). The housing 40 has connectors 41, 42 protruding outward from a side wall of the housing 40 and configured to connect the electronic circuit of the wiring unit 100 to an electronic circuit of another device. Further, the wiring unit 100 has a lid (not shown) for closing the upper opening of the housing 40 such that the first and second conductive members 10, 20 and the electronic components are covered with the housing 40 and the lid. However, most of the second conductive member 20 is exposed from the bottom of the housing 40 (FIG. 2).

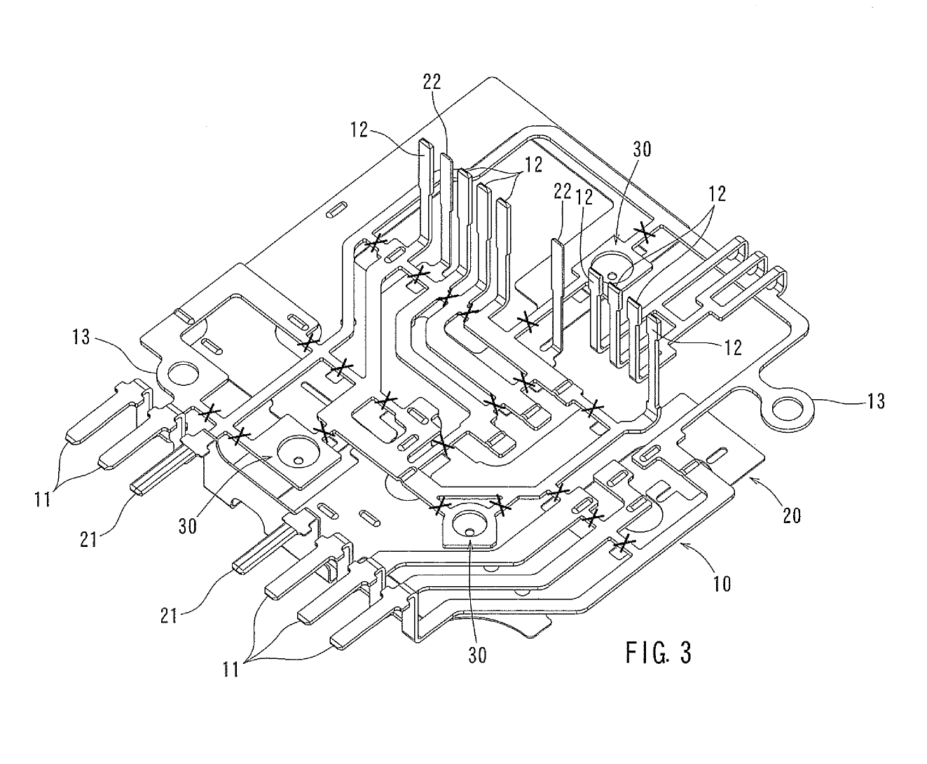

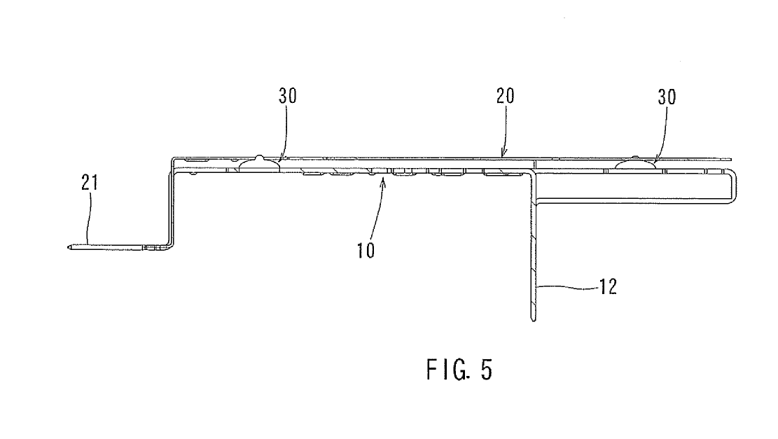

FIGS. 3 to 5 show the first and second conductive members 10, 20 before they are buried in the housing 40. The first conductive member 10 includes a wiring part serving as both a power line and signal lines of the electronic circuit, whereas the second conductive member 20 includes a wiring part for a bottom side line, i.e., a line of a ground side. Each of the wiring parts of the first and second conductive members 10, 20 is formed in a flat plate shape. The first conductive member 10 is thicker than the second conductive member 20. In this embodiment, the first conductive member 10 has the plate thickness of 0.64 mm, whereas the second conductive member 20 has the plate thickness of 0.3 mm. The second conductive member 20 has a larger surface area than the first conductive member 10.

The first conductive member 10 has a plurality of terminals each extending from the wiring part of the first conductive member 10. Some of the terminals are connector terminals 11 bent to shift upward such that the connector terminals 11 extend within the connector 41 or the connector 42. And, some of the terminals are connection terminals 12, which are bent to extend upward. The connection terminals 12 are configured to be connected to terminals of the IC, which is housed in the housing 40 and is fixed at the upper side of the housing 40. Further, the first conductive member 10 has a pair of positioning parts 13 integrated with the wiring part of the first conductive member 10 in order to position the first conductive member 10 within a molding die during insert molding. One of the positioning parts 13 is formed at a corner of a circumference of the first conductive member 10 and near the connector terminals 11, whereas the other one is formed near the connection terminals 12.

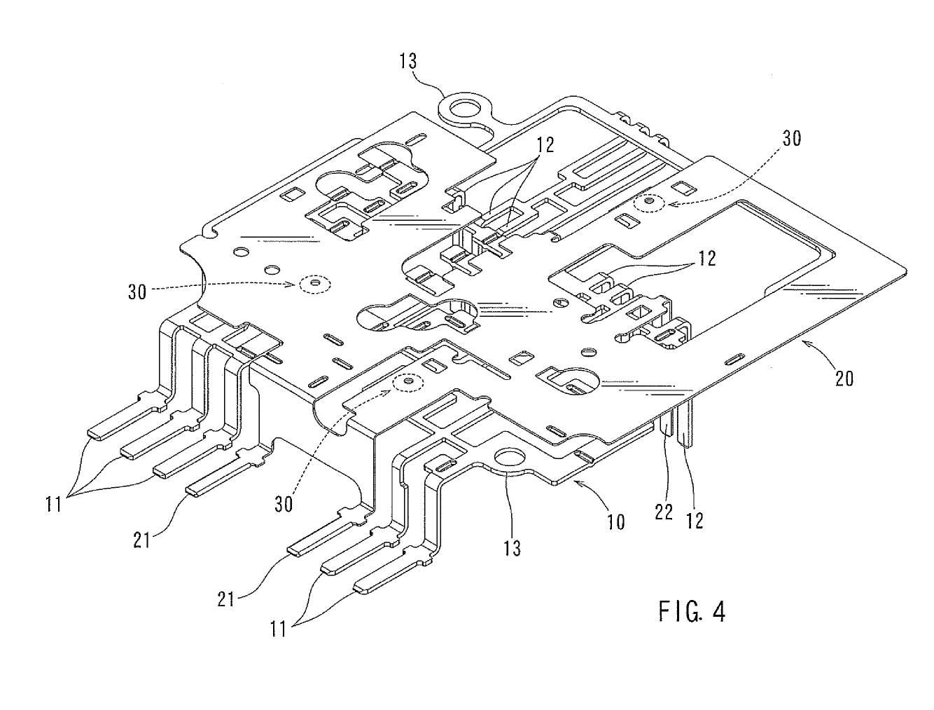

The second conductive member 20 is formed to have a larger surface area than the first conductive member 10 in order to widely cover the wiring part of the first conductive member 10 in a condition where the first and second conductive members 10, 20 are layered (FIGS. 3 and 4). The second conductive member 20 has a plurality of terminals each extending from the wiring part of the second conductive member 20. Some of the terminals of the second conductive member 20 are connector terminals 21 bent to be aligned with the connector terminals 11 of the first conductive member 10 and to extend in the connector 41 or the connector 42. Whereas, some of the terminals are connection terminals 22, which are bent to be aligned with the connection terminals 12 of the first conductive member 10 and are configured to be connected to the terminals of the IC. Because the second conductive member 20 is thinner than the first conductive member 10 as described above, each of the connector terminals 21 is folded in two to have the substantial same thickness with the connector terminals 11.

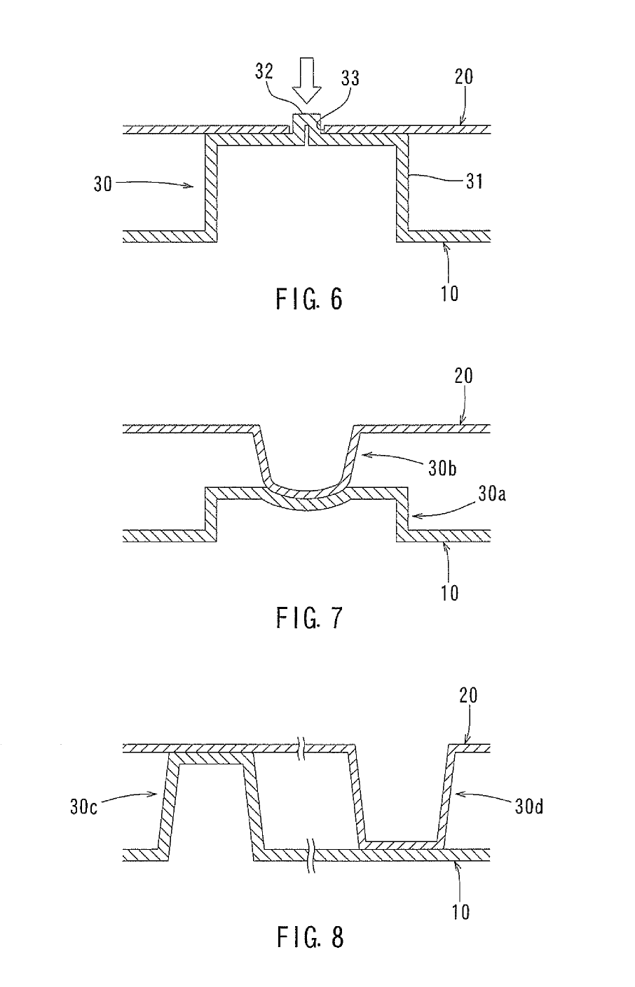

Referring to FIG. 3, the first conductive member 10 has a plurality of protrusions 30. The protrusions 30 are formed by partially stretching a surrounding area of the wiring part of the first conductive member 10 when punching the copper plate. The protrusions 30 are located at three positions of the first conductive member 10, in more detail, at a first position near the connector terminals 11, 21 for the connector 41, at a second position near the connector terminals 11, 21 for the connector 42, and a third position near the connection terminals 12, 22 to be connected to the terminals of the IC. Because each of the protrusions 30 has substantially the same configuration, only one of the protrusions 30 will be described, and explanation of the other protrusions 30 will be omitted. As shown in FIG. 6, the protrusion 30 has a convex part 31, which is made by partially stretching the first conductive member 10 toward the second conductive member 20 and is formed in a hollow cylindrical shape such that an end surface of the convex part 31 is in a surface contact with a corresponding region of the second conductive member 20. The protrusion 30 has a projection 32 extending from a center of the end surface of the convex part 31. The second conductive member 20 has through-hole 33 at each corresponding region such that the projection 32 is inserted into and extends through the through-hole 33. In a condition where the projection 32 projects from the through-hole 33, a tip end of the projection 32 is swaged, i.e., is deformed into a larger diameter structure by applying pressure to the tip end of the projection 32 along a direction shown by a white block arrow in FIG. 6, so that the through-hole 33 is closed with the deformed tip end of the projection 32 in order to engage the first and second conductive members 10, 20 with each other. The convex part 31 of the protrusion 30 has the same length in its extending direction with the other convex parts 31 such that the first and second conductive members 10, 20 are layered in parallel to each other. In this embodiment, the convex part 31 of the protrusion 30 has a length in the extending direction of 1.18 mm and a diameter of 6 mm.

During insert molding, the first and second conductive members 10, 20 are layered with the protrusions 30 therebetween, are integrated with each other, and are held as the insert material in a molding die (not shown) for insert molding of a resin material. The layered first and second conductive members 10, 20 correspond to a conductive substrate in this disclosure. In this process, the pair of the positioning parts 13 of the first conductive member 10 position the first and second conductive members 10, 20 with respect to the molding die. When injecting the resin material into the molding die from outside, the first and second conductive members 10, 20 serve as the insert material are subject to flow pressure of the resin material. However, the first and second conductive members 10, 20 are integrated with each other by the three protrusions 30 in a parallel condition or arrangement with a predetermined space therebetween, so that the housing 40 is integrally molded with the first and second conductive members 10, 20 remaining in the parallel condition.

After the molding process, reinforcing connections of the wiring part of the first conductive member 10, which are not necessary for the electronic circuit, are cut. While, the protrusions 30 are cut away from the wiring part of the first conductive member 10. In FIG. 3, each of these cutting sites is indicated by “X”. Here, it is important that these cutting sites are cut after insert molding. When the first conductive member 10 does not include the reinforcing connections, the stiffness of the wiring part of the first conductive member 10 is low. Accordingly, without the reinforcing connections there is a possibility that the first conductive member 10 will move during the insert molding due to the flow pressure of the resin material, thereby resulting in undesirable contact between lines formed in the wiring parts of the first and second conductive members 10, 20. Accordingly, the reinforcing connections of the first conductive member 10 prevent such undesirable contact between the lines of the wiring units, and thus can reduce defective products during the insert molding.

According to this embodiment, the protrusions 30 of the first conductive member 10 can hold the wiring parts of the first and second conductive members 10, 20 in a parallel condition with the predetermined space therebetween during the insert molding, and then are cut away from the first conductive member 10. Accordingly, it is able to make the wiring unit 100, in which the first and second conductive members 10, 20 are layered with each other, without using any tool holding the first and second conductive members 10, 20 spaced away from each other. Further, each of the protrusions 30 is formed in a hollow cylindrical shape in order to increase mechanical strength of the protrusion 30 for holding the first and second conductive members 10, 20 in the parallel condition. In addition, each of the protrusions 30 is in the surface contact with the second conductive member 20. Accordingly, such surface contact can stabilize the parallel arrangement of the first and second conductive members 10, 20 such that the wiring part of the conductive member 10 is distant from the wiring part of the second conductive member 20. Furthermore, the projections 32 are deformed by swaging in order to fix the first and second conductive members 10, 20 to each other. Thus, the surface contacts between the first and second conductive members 10, 20 are stabilized, so that the parallel condition of the first and second conductive members 10, 20 can be stably maintained. After the insert molding, the protrusions 30 are cut away from the first conductive member 10. However, the protrusions 30 remain in the molded resin such that the second conductive member 20 is integrated with the molded resin via the projections 30. Hence, if the strength of the integration between the molded resin and the second conductive member 20 is not enough, the possibility of deformation of the second conductive member 20 can be reduced due to the connection to the projections 30. As shown in FIG. 2, the second conductive member 20 is integrated with the molded resin formed in a lattice-like shape composed of thin strips, so that the strength of the integration of the molded resin with respect to the second conductive member 20 is not strong.

The protrusions 30 are located independently from the wiring part of the first conductive member 10, and thus can be formed without any influence of the wiring part. Accordingly, the protrusions 30 can be easily provided at positions preferred for holding the wiring part of the first conductive member 10 away from the second conductive member 20. The protrusions 30 should be electrically cut from the first and second conductive members 10, 20. Because the protrusions 30 are provided independently from the wiring part of the conductive member 10, cutting process of the protrusions 30 can be easily performed.

The second conductive member 20 has a larger surface area than the first conductive member 10. Thus, it is able to decrease the impedance of the lines of the second conductive member 20 at the bottom side, thereby stabilizing grounding potential. Because the bottom side lines of the second conductive member 20 cover the power line and the signal lines of the first conductive member 10, noise in the electronic circuit can be reduced due to shielding effectiveness of the bottom side lines. Further, the protrusions 30 are formed at the thicker first conductive member 10, so that the mechanical strength of each protrusion 30 is increased in order to stably maintain the parallel condition of the first and second conductive members 10, 20 with the predetermined space therebetween.

In a second embodiment, each of the protrusions 30 in the first embodiment is replaced with a combination of a first protrusion 30a and a second protrusion 30b as shown in FIG. 7. Other configurations of the second embodiment are same with those of the first embodiment, and thus will not be described again. The first conductive member 10 has the first protrusions 30a, each of which has a hollow cylindrical part and a tip end having a concave surface. Whereas the second conductive member 20 has the second protrusions 30b each configured to fit with the concave surface of the corresponding first protrusion 30a. According to this configuration, relative movement between the first and second conductive members 10, 20 can be prevented without swaging of the projections 32.

In a third embodiment shown in FIG. 8, the first conductive member 10 has at least one third protrusion 30c, whereas the second conductive member 20 includes at least one fourth protrusion 30d instead of the protrusions 30 of the first embodiment. Other configurations of the third embodiment are same with those of the first embodiment, and thus will not be described again. The third protrusion 30c is formed to extend toward the second conductive member 20 such a tip end of the third protrusion 30c is in surface contact with the second conductive member 20. Also, the fourth protrusion 30d extends toward the first conductive member 10 and has a tip end contacting the first conductive member 10. Of course, contact structures between the protrusions 30c, 30d and the conductive members 10, 20 can be configured to be similar to the engagement structure between the projection 32 and the through-hole 33 as shown in FIG. 6.

The present disclosure can be modified without departing from the scope of the invention. For example, the protrusions can be provided at the second conductive member 20 only. When the first and second conductive members 10, 20 need electric connection therebetween or when such electric connection between the first and second conductive members 10, 20 does not cause any problem, it is not necessary to block the electric connection. Further, the protrusions may be provided at two positions or four or more positions. The wiring unit may include three or more conductive members.

What is claimed is:

1. A wiring unit for an electronic circuit, comprising:
a housing made from a resin material; and
a first conductive member and a second conductive member each partially buried in the housing and each including a wiring part formed in a plate shape;
wherein the wiring parts of the first and second conductive members are layered and are spaced from each other;
wherein one of the first and second conductive members includes a plurality of protrusions extending toward the other one of the first and second conductive members; and
wherein the first and second conductive members are engaged with each other via the protrusions.

2. The wiring unit according to claim 1,
wherein the first and second conductive members are engaged with each other by swaging the protrusions.

3. The wiring unit according to claim 1,
wherein the first conductive member constitutes a power line and a signal line of the electronic circuit;
wherein the second conductive member constitutes a ground side line of the electronic circuit; and
wherein the second conductive member has a larger surface area than the first conductive member.

4. The wiring unit according to claim 3,
wherein the first conductive member includes the protrusions; and
wherein the first conductive member is thicker than the second conductive member.

5. The wiring unit according to claim 1,
wherein one of the protrusions includes a contact surface directed toward the other one of the first and second conductive members and a projection extending from the contact surface;
wherein the other one of the first and second conductive members includes a flat surface having a through-hole; and
wherein the first and second conductive members are engaged with each other by swaging a tip end of the projection when the contact surface is in a surface contact with the flat surface and when the projection is inserted into the through-hole.

6. The wiring unit according to claim 5,
wherein the protrusions are located at positions independent from the wiring parts.

7. A method of manufacturing a wiring unit, the method comprising:
deforming one of a pair of plate-shaped conductive members in order to form a plurality of protrusions;
layering the conductive members such that the protrusions are located between the conductive members;
molding a resin material into a wiring unit integrated with the layered conductive members; and
disconnecting electrical connections between the conductive members integrated with the wiring unit.

8. A conductive substrate, comprising:
a first conductive member and a second conductive member each having a wiring part formed in a plate shape;
wherein the first conductive member includes a plurality of protrusions extending toward the second conductive member; and
wherein the first and the second conductive members are engaged with each other via the protrusions such that the wiring parts of the first and second conductive members are layered and are spaced from each other.
